(19) United States
(12) Patent Application Publication
(10) Pub. No.: US 2016/0174140 A1
(43) Pub. Date: Jun. 16, 2016

(54) METHOD AND DEVICE FOR PERFORMING CONFIGURATION

(71) Applicant: Xiaomi Inc., Beijing (CN)

(72) Inventors: Ping Wu, Beijing (CN); Xin Liang, Beijing (CN); Xin Liu, Beijing (CN); Bo Liu, Beijing (CN)

(21) Appl. No.: 14/863,465

(22) Filed: Sep. 24, 2015

Related U.S. Application Data
(63) Continuation of application No. PCT/CN2015/078018, filed on Apr. 30, 2015.

(30) Foreign Application Priority Data
Dec. 12, 2014 (CN) 201410771880.2

(51) Int. Cl. H04W 48/16; H04W 12/06; H04L 29/06; H04W 72/00; H04W 76/02

(52) U.S. Cl. CPC H04W 48/16; H04W 72/005; H04W 76/02; H04L 69/22; H04W 12/06; H04L 63/0876; H04L 63/083; H04W 84/12

(57) ABSTRACT

The embodiments of the present disclosure provide a method and a device for performing configuration. Taking an example in which a first terminal device is a mobile terminal device and a second terminal device is a smart television, the method implemented in the mobile terminal device includes: generating a WIFI frame containing configuration data for configuring the smart television; and broadcasting the WIFI frame so that the smart television is able to configure itself according to the configuration data after receiving the WIFI frame. In the embodiments of the present disclosure, no connection needs to be pre-established between the mobile terminal device (such as a mobile phone and the like) and the smart television.

### CROSS-REFERENCE TO RELATED APPLICATIONS

This application is a Continuation of International Application No. PCT/CN2015/078018, filed on Apr. 30, 2015, which is based on and claims priority to Chinese Patent Application No. 201410771880.2, filed on Dec. 12, 2014, the entire contents of which are incorporated herein by reference.

### TECHNICAL FIELD

The present disclosure generally relates to the technical field of communication between terminal devices, and more particularly, to methods and devices for performing configuration.

### BACKGROUND

With the development of technology, it is expected to get rid of complex cables and cumbersome steps during configuration of a terminal device. Taking a smart television as an example, smart televisions are used in a large number of households today. Compared with a conventional television, a smart television has more functions such as access to wireless Internet and downloading data, etc. In addition to directly purchasing a smart television, a user may also purchase a smart TV box, which may be connected to a conventional television. Then the conventional television may function as a smart television.

A smart television is required to achieve functions such as wireless Internet access. In related art, a remote control unit may be used to configure a smart television. For example, the remote control unit is used to instruct the smart television to scan for a list of currently available WIFI networks. Then a WIFI network is selected to be connected to. Finally WIFI passwords are inputted from a remote control of the television and a wireless connection is thus established.

### SUMMARY

According to a first aspect of the embodiments of the present disclosure, a method for performing configuration in a first terminal device is provided. The method includes: generating a WIFI frame including configuration data for configuring a second terminal device; and broadcasting the WIFI frame so that the second terminal device is able to configure itself according to the configuration data after receiving the WIFI frame.

According to a second aspect of the embodiments of the present disclosure, a method for performing configuration in a second terminal device is provided. The method includes: intercepting a WIFI frame sent by a first terminal device, the WIFI frame including configuration data for configuring the second terminal device; acquiring the configuration data after intercepting the WIFI frame; and performing configuration according to the configuration data.

According to a third aspect of the embodiments of the present disclosure, a first terminal device for performing configuration is provided, including: a processor; and a memory configured to store instructions executable by the processor. The processor is configured to perform: generating a WIFI frame including configuration data for configuring a second terminal device; and broadcasting the WIFI frame so that the second terminal device is able to configure itself according to the configuration data after receiving the WIFI frame.

According to a fourth aspect of the embodiments of the present disclosure, a second terminal device for performing configuration is provided, including: a processor; and a memory configured to store instructions executable by the processor. The processor is configured to perform: intercepting a WIFI frame sent by a first terminal device, the WIFI frame including configuration data for configuring the second terminal device; acquiring the configuration data after intercepting the WIFI frame; and performing a configuration according to the configuration data.

In the embodiments of the present disclosure, no connection needs to be pre-established between the first terminal device (taking a mobile phone as an example) and the second terminal device (taking a smart television as an example). The mobile phone provides configuration data in a WIFI frame and then broadcasts the configuration data, the smart television initiates a data interception interface and configures itself according to the configuration data received from the WIFI frame. For example, the mobile phone may provide an SSID and a password of a WIFI network in Probe Request so that the smart television is able to connect with the WIFI network using the SSID (Service Set Identifier) and the password. In this way, a WIFI network discovered by the mobile phone is shared to the smart television in an efficiently way which avoids cumbersome configuration of the smart television and improves operating efficiency in configuring terminal devices.

It is to be understood that both the foregoing general description and the following detailed description are exemplary and explanatory only and are not restrictive of the disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart showing a method for performing configuration according to an exemplary embodiment.

FIG. 2 is a flow chart showing a method for performing configuration according to an exemplary embodiment.

FIG. 3 is a schematic diagram showing a scenario of performing configuration of a smart television according to an exemplary embodiment.

FIG. 4 is a schematic diagram showing an operation interface according to an exemplary embodiment.

FIG. 5 is a flow chart showing a method for performing configuration according to an exemplary embodiment.

FIG. 6 is a schematic diagram showing a scenario of performing configuration of a smart television according to an exemplary embodiment.

FIG. 7 is a flow chart showing a method for performing configuration according to an exemplary embodiment.

FIG. 8 is a flow chart showing a method for performing configuration according to an exemplary embodiment.

FIG. 9 is a flow chart showing a method for performing configuration according to an exemplary embodiment.

FIG. 10 is a signaling diagram showing a method for performing configuration according to an exemplary embodiment.

FIG. 11 is a signaling diagram showing a method for performing configuration according to an exemplary embodiment.

FIG. 12 is a block diagram showing an apparatus for performing configuration according to an exemplary embodiment.

FIG. 13 is a block diagram showing an apparatus for performing configuration according to an exemplary embodiment.

FIG. 14 is a block diagram showing an apparatus for performing configuration according to an exemplary embodiment.

FIG. 15 is a block diagram showing an apparatus for performing configuration according to an exemplary embodiment.

FIG. 16 is a block diagram showing an apparatus for performing configuration according to an exemplary embodiment.

FIG. 17 is a block diagram showing an apparatus for performing configuration according to an exemplary embodiment.

FIG. 18 is a block diagram showing a terminal device for performing configuration according to an exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

The embodiments of the present disclosure disclose a method for performing configuration, which is applicable to a first terminal device, including: generating a WIFI frame, which includes configuration data for configuring a second terminal device; and broadcasting the WIFI frame so that the second terminal device is able to configure itself according to the configuration data after receiving the WIFI frame.

Optionally, the WIFI frame is generated by adding the configuration data into a predefined field of the WIFI frame, and the WIFI frame may be a Management Frame, a Control Frame or a Data Frame.

Optionally, the configuration data includes an SSID (Service Set Identifier) and a connection password.

Moreover, the step of adding the configuration data into a predefined field of the WIFI frame includes: acquiring SSIDs and connection passwords of networks saved in the first terminal device and choosing an SSID and a connection password of a network from the acquired SSIDs and the acquired connection passwords for the configuration of the second terminal device; and writing the SSID and the connection password of the chosen network into the predefined field of the WIFI frame to generate the WIFI frame so that the second terminal device is able to connect with the chosen network according to the configuration data after receiving the WIFI frame.

Optionally, the configuration data includes: an SSID, a connection password, a channel number and an encryption mode.

Moreover, the step of adding the configuration data in a predefined field of the WIFI frame includes: receiving an SSID, a connection password, a channel number and an encryption mode inputted from a user; and writing the SSID, the connection password, the channel number and the encryption mode into the predefined field of the WIFI frame to generate the WIFI frame so that the second terminal device is able to create a wireless network according to the configuration data after receiving the WIFI frame.

Optionally, the step of generating the WIFI frame includes: partitioning the configuration data into at least two parts according to a preset rule if the number of bytes of the configuration data exceeds a preset threshold; and generating a plurality of WIFI frames, each of which including one of the at least two parts.

Optionally, the step of broadcasting the WIFI frame includes: successively broadcasting the plurality of the WIFI frames so that the second terminal device is able to configure itself according to the configuration data by combining the part of configuration data in the predefined field of each WIFI frame according to the preset rule after receiving the WIFI frame.

The embodiments of the present disclosure also disclose a method for performing configuration, which is applicable to a second terminal device, including: intercepting a WIFI frame sent by a first terminal device, which includes configuration data for configuring the second terminal device; acquiring the configuration data by parsing the WIFI frame; and performing the configuration according to the configuration data.

Optionally, the configuration data is acquired by parsing a predefined field of the WIFI frame.

Optionally, the configuration data includes: an SSID and a connection password; and the step of performing the configuration according to the configuration data includes: connecting with corresponding networks according to the SSID and the connection password.

Optionally, the configuration data includes: an SSID, a connection password, a channel number and an encryption mode; and the step of performing the configuration according to the configuration data includes: creating a wireless network according to the SSID, the connection password, the channel number and the encryption mode.

Optionally, the step of acquiring the configuration data by parsing the predefined field of the WIFI frame includes: judging whether a plurality of WIFI frames are intercepted and whether the predefined field of each WIFI frame comprises a part of configuration data; and acquiring the configuration data by combining the part of configuration data of each WIFI frame according to a preset rule if the plurality of the WIFI frames are intercepted and the predefined field of each WIFI frame comprises the part of the configuration data.

The embodiments of the present disclosure also disclose a device for performing configuration, including: a processor; and a memory configured to store instructions executable by the processor; wherein, the processor is configured to: generate a WIFI frame, which includes configuration data for configuring a second terminal device; and broadcast the WIFI frame so that the second terminal device is able to configure itself according to the configuration data after receiving the WIFI frame.

The embodiments of the present disclosure also disclose a device for performing configuration, including: a processor; and a memory configured to store instructions executable by the processor; wherein, the processor is configured to: intercept a WIFI frame sent by a first terminal device, the WIFI frame including configuration data for configuring the second terminal device; acquire the configuration data by parsing the WIFI frame; and perform the configuration according to the configuration data.

The first terminal device may include a mobile terminal such as a mobile phone, a tablet computer and the like, and the second terminal device may include a smart television (including a smart TV box) or a smart sound box, etc. The WIFI frame may include a Data Frame, a Management Frame and a Control Frame, and a Probe Request belongs to one type of the Management Frame. Further description of the solution of the present disclosure will be made by taking an example in which the WIFI frame is Probe Request, the predefined field is an SSID field, the first terminal device is a mobile terminal such as a mobile phone and the second terminal device is a smart television.

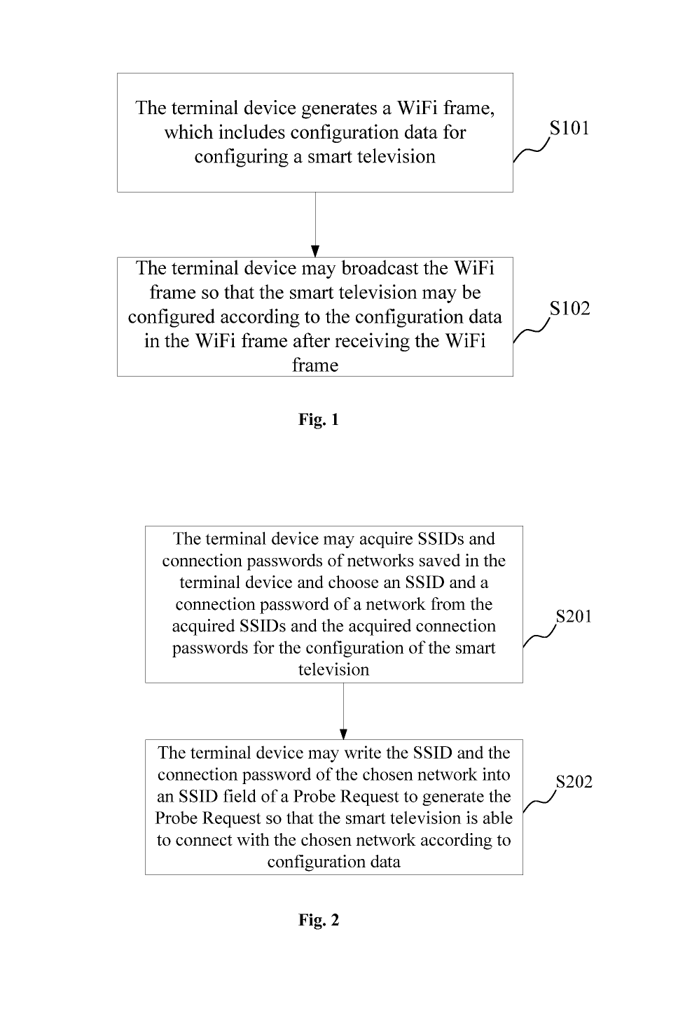

FIG. 1 is a flow chart showing a method for performing configuration according to an exemplary embodiment. The method may be applied to a terminal device such as a mobile phone, a tablet computer and the like. Referring to FIG. 1, the method may include following steps.

In Step S101, the terminal device generates a WIFI frame, which includes configuration data for configuring the smart television.

When the smart television is configured, for example, to make it be able to connect to a certain WIFI access point or to make the smart television itself serve as a WIFI access point, the terminal device may be used to generate the configuration data for configuring the smart television and the configuration data is then carried in the WIFI frame.

In Step S102, the terminal device may broadcast the WIFI frame so that the smart television may be configured according to the configuration data in the WIFI frame after receiving the WIFI frame.

In the present embodiment, no connection needs to be pre-established between the terminal device, such as a mobile phone and the like, and the smart television. Instead, the smart television sets up a data interception interface to intercept the WIFI frame broadcasted by the mobile phone. After intercepting the WIFI frame, the smart television may extract the configuration data from the WIFI frame and perform corresponding configuration operation, thus achieving functions of connecting to a certain WIFI access point or serving as a WIFI access point, etc.

The present embodiment makes not limitation to the frame type, the frame structure and other properties of the WIFI frame. As an example, the WIFI frame may be Probe Request in 802.11 protocol. The step of generating a WIFI frame may include: generating a Probe Request before establishing a communication connection with the smart television, configuration data being placed in an SSID field of the Probe Request.

The Probe Request is used to scan existing 802.11 networks in an area. The device may send an active Probe Request and wait for a response, such as a Probe Response, from an access point (AP), thereby achieving AP discovery. In the process of implementation of the solution provided in the present disclosure, it is found that a Probe Request may be employed to bear configuration data, thus no connection needs to be pre-established between the terminal device and the smart television, and the smart television only needs interception, which further simplifies the operation process in configuring the smart television.

The Probe Request includes an SSID field (SSID element content), which is usually set as an SSID of a specific network or of any network, and has a maximum field length of 32 bytes. In the embodiments of the present disclosure, configuration data may be placed in the field.

In the present embodiment or other embodiments of the present disclosure, configuration data may include an SSID and a connection password.

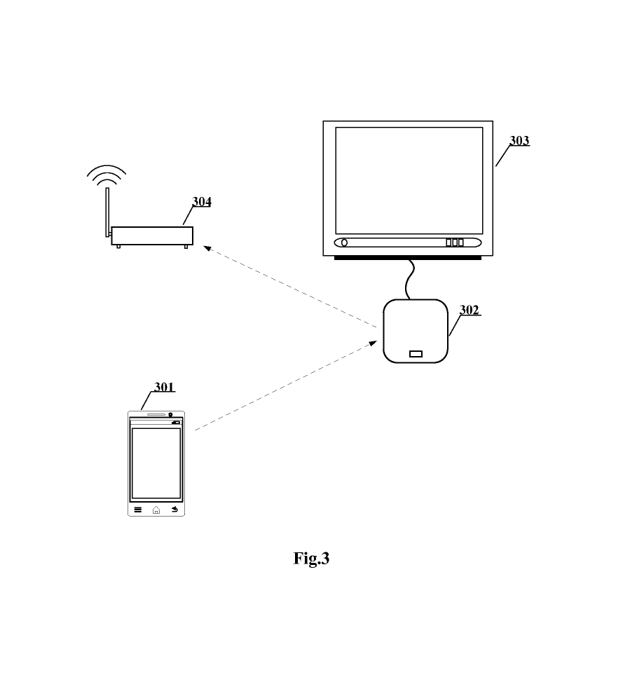

Correspondingly, referring to FIG. 2, the step of generating a Probe Request may include following steps.

In Step S201, the terminal device may acquire SSIDs and connection passwords of networks saved in the terminal device and choose an SSID and a connection password of a network from the acquired SSIDs and the acquired connection passwords for the configuration of the smart television; and

In Step S202, the terminal device writes the SSID and the connection password of the chosen network into the SSID field of a Probe Request to generate the Probe Request so that the smart television is able to connect with the chosen network according to the configuration data after receiving the WIFI frame.

Thus it is equivalent to a fact that information on WIFI access point is shared by the terminal device with the smart television so that the smart television may be directly connected to the corresponding WIFI access point according to the SSID and the connection password received without necessity to configure the smart television by using the remote control unit.

As an example, a scenario is provided in FIG. 3 which shows a terminal device 301 such as a mobile phone, a smart TV box 302 (abbreviated as the TV box), a television 303 and an access point (AP) 304 of a WiFi network. The TV box 302 and the television 303 jointly constitute a smart television. The mobile phone 301 may broadcast both the SSID and the connection password of the WiFi network, and the TV box 302 may be connected to the WiFi network after receiving both the SSID and the connection password.

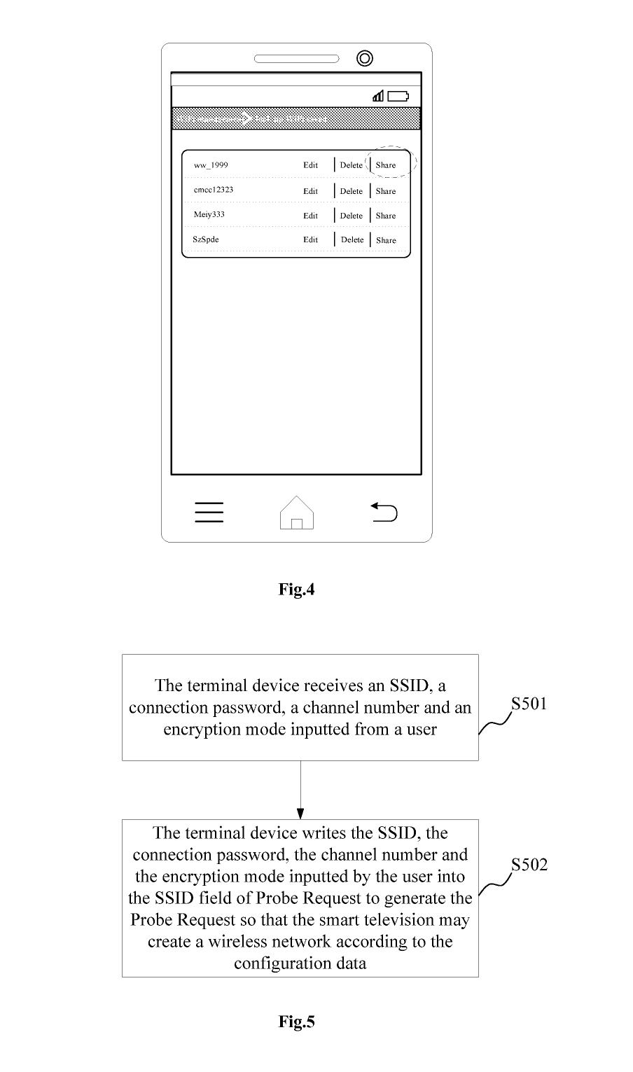

On the interface as shown in FIG. 4, the user may see SSIDs of the WIFI networks currently saved in the mobile phone. Both the SSID and the connection password of the WIFI may be encapsulated by the mobile phone into a Probe Request and be broadcasted to be shared with the smart television for use if the user clicks a “Share” button.

In the present embodiment or other embodiments of the present disclosure, the configuration data may also include an SSID, a connection password, a channel number and an encryption mode.

Correspondingly, as shown in FIG. 5, the step of generating a Probe Request may include following steps.

In Step S501, the terminal device receives a SSID, a connection password, a channel number and an encryption mode inputted from a user.

Then in Step S502, the terminal device writes the SSID, the connection password, the channel number and the encryption mode inputted by the user into the SSID field of the Probe Request to generate the Probe Request so that the smart television may create a wireless network according to the configuration data.

In this way, a wireless access point is created for the smart television by means of mobile phone instruction, without necessity to establish a connection with the smart television in advance or performing cumbersome operation on the remote control unit.

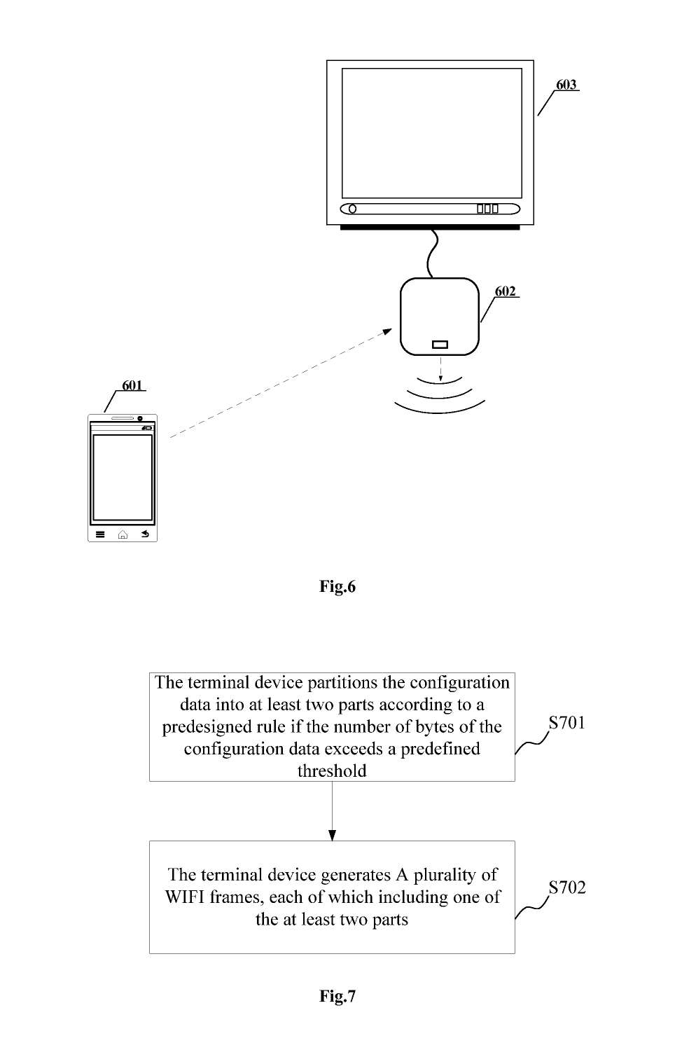

As an example, a scenario is provided in FIG. 6 which shows a mobile phone 601, a TV box 602 and a television 603. The TV box 602 and the television 603 together form a smart television. After the mobile phone 601 sends an SSID, a connection password, a channel number and an encryption mode to the TV box 602, the TV box 602 may act as an AP and establish a wireless network according to the configuration data. After the establishment of the wireless network by the smart television, the mobile phone may be connected to the smart television through the wireless network for data transmission.

Additionally, in some cases, the number of bytes of the configuration data may exceed a preset length of the WIFI frame. For example, some WIFI networks may have very long passwords, but the SSID field in Probe Request has only 32 bytes at most.

Referring to FIG. 7, in the present embodiment or other embodiments of the present disclosure, the step of generating the WIFI frame includes following steps.

In Step S701, the terminal device partitions the configuration data into at least two parts according to a preset rule if the number of bytes of the configuration data exceeds a predefined threshold; and

In Step S702, the terminal device generates a plurality of WIFI frames, each of which includes one of the at least two parts.

In the present embodiment or other embodiments of the present disclosure, the step of broadcasting the WIFI frame may include: successively broadcasting the plurality of the WIFI frames generated so that the smart television is able to configure itself according to the configuration data by combining the part of configuration data in the predefined field of each WIFI frame according to the preset rule after receiving the plurality of the WIFI frames

For example, the configuration data may be equally partitioned into N parts according to the preset rule, and placed in N WIFI frames. And multiple indication signs may be set in each WIFI frame for indicating association relationships among data of respective parts. In this way, after the smart television receives one of the WIFI frames, it may be judged that which part of configuration data the data in the WIFI frame belongs to, and whether all WIFI frames of the configuration data are received.

FIG. 8 is a flow chart showing a method for performing configuration according to an exemplary embodiment. The method may be applied to a smart television. Referring to FIG. 8, the method may include following steps.

In Step S801, the smart television intercepts a WIFI frame sent by a terminal device, which includes configuration data for configuring the smart television.

In Step S802, after intercepting a WIFI frame, the smart television parses the WIFI frame and acquires the configuration data.

In Step S803, the smart television performs a configuration according to the configuration data.

In the present embodiment or other embodiments of the present disclosure, the WIFI frame may be a Probe Request in 802.11 protocol, and the configuration data may be placed in the SSID field of the Probe Request.

In the present embodiment or other embodiments of the present disclosure, the step of parsing the WIFI frame and acquiring the configuration data after intercepting the WIFI frame may include: parsing the SSID field of the Probe Request and acquiring the configuration data after intercepting the Probe Request.

In the present embodiment or other embodiments of the present disclosure, the configuration data may include an SSID and a connection password; and the step of performing the configuration according to the configuration data includes: connecting a corresponding network according to the SSID and the connection password.

Alternatively, the configuration data may include: an SSID, a connection password, a channel number and an encryption mode; and the step of performing the configuration according to the configuration data includes: creating a wireless network according to the SSID, the connection password, the channel number and the encryption mode.

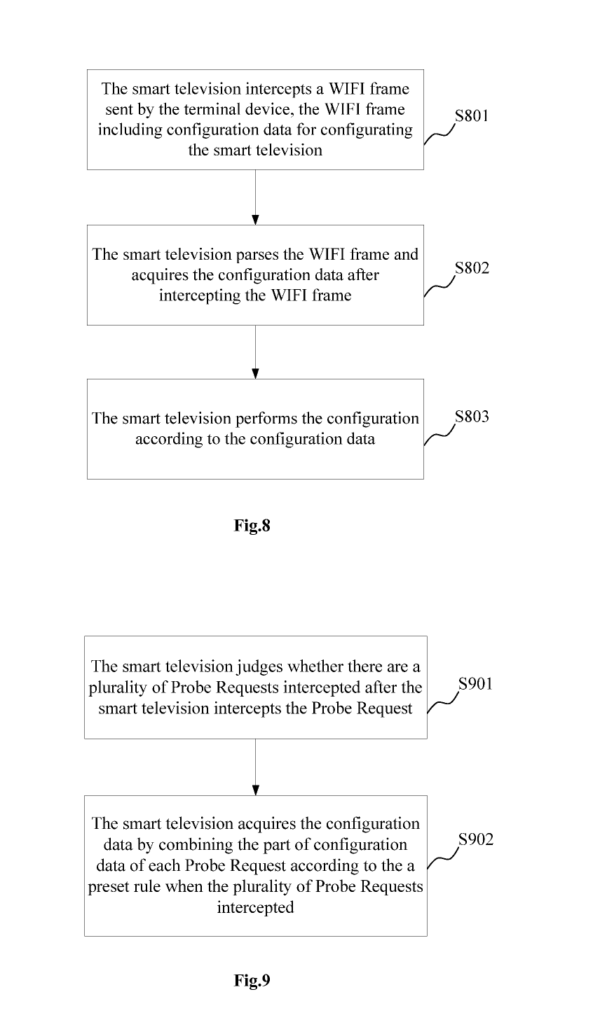

In addition, in the present embodiment or other embodiments of the present disclosure, when a number of bytes of the configuration data exceeds the preset threshold, for example, the length of the WIFI frame, the terminal device may partition the configuration data into at least two parts according to a preset rule, each part of which may be placed in a WIFI frame. Correspondingly, referring to FIG. 9, the step of parsing the SSID field of Probe Request and acquiring the configuration data after intercepting the Probe Request by the smart television includes following steps.

In Step S901, it is judged whether there are a plurality of Probe Requests intercepted after the smart television intercepts Probe Request.

In Step S902, the smart television acquires the configuration data by combining the part of configuration data of each Probe Request according to a preset rule when the plurality of Probe Requests are intercepted.

Further description of the present disclosure will be made in combination with two concrete scenarios.

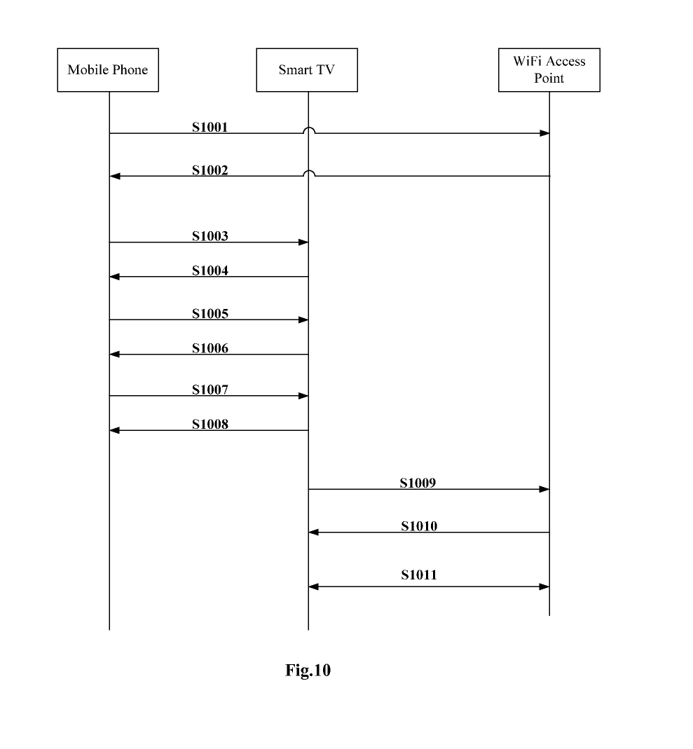

FIG. 10 is a signaling diagram showing a method for performing configuration according to an exemplary embodiment. In the scenario of the present embodiment, the terminal device is a mobile phone, and the network that the smart television is configured by the terminal device to connect with is a WIFI network or a WIFI access point. In addition, the configuration data is partitioned by the mobile phone into three frames of Probe Request before being broadcasted due to a relatively large number of bytes of the configuration data.

In Step S1001, the mobile phone sends a connection request to the WIFI access point according to a connection password provided by the user.

In Step S1002, the WIFI access point sends feedback information to the mobile phone and a connection is established.

Successful connection indicates the connection password of the WIFI access point is correct, and thus the connection password may be saved in the mobile phone for future use. Of course, the actual process of establishing the connection between the mobile phone and the WIFI access point may be more complex than Steps S1001˜S1002, for example, there may be several interactions before the establishment of a successful connection. However, Steps S1001˜S1002 give a simplified description for easy understanding.

In Step S1003, the mobile phone broadcasts a first Probe Request frame.

In Step S1004, the smart television feeds back a Probe Response after receiving the first Probe Request frame.

In Step S1005, the mobile phone broadcasts a second Probe Request frame.

In Step S1006, the smart television feeds back a Probe Response after receiving the second Probe Request frame.

In Step S1007, the mobile phone broadcasts a third Probe Request frame.

In Step S1008, the smart television feeds back a Probe Response after receiving the third Probe Request frame.

Specific contents of Probe Request are illustrated as below.

For example, the SSID of the WiFi network to be connected with is “mitv_24GAPABCD EFGHIJKLM” (23 bytes) and the connection password is “1234567890abcdefghi gklmnopqrs” (29 bytes), so the combination of the SSID and the connection password of the WiFi network is “mite_24GAPABCDEFGHIJKLM1234567890abcdefghigklmnopqrs” (52 bytes), which may be partitioned into three parts: “mitv_24GAPABCDEFGHIJKLM1” (24 bytes), “234567890abcdefghigklmnopq” (26 bytes) and “rs” (2 bytes). In addition, the configuration data also includes a data field (Ssid len) indicating a length of the SSID of the WiFi network in bytes, a data field (Password len) indicating a length of the password in bytes, and a data field indicating a password type and an encryption Type. The length of the configuration data is two bytes in total. Therefore, the total number of bytes (Total len) of the configuration data is 54 (Note: 1 byte=8 bits).

The SSID field of the first Probe Request frame broadcasted by the mobile phone may be constituted as follows:

| | | | | | Password | | | Sub |
|---|---|---|---|---|---|---|---|---|
| Flag | version | Index | Total len | Ssid len | len | Password | key_mgmt | Payload |
| (4 byte) | (4 bit) | (4 bit) | (1 byte) | (6 bit) | (6 bit) | type (1 bit) | (3 bit) | (24 byte) |
| XMKL | 1 | 1 | 54 | 23 | 29 | 0 | 3: wpa | mitv_24GAPABCDEFGHIJKLM1 |

| | |
|---|---|
| Plaintext | Ciphertext |

The SSID field of the second Probe Request frame broadcasted by the mobile phone may be constituted as follows:

| Flag | version | Index | Total len | Payload |
|---|---|---|---|---|
| (4 byte) | (4 bit) | (4 bit) | (1 byte) | (26 byte) |
| XMKL | 1 | 2 | 54 | 234567890abcdefghigklmnopq |

| | |
|---|---|
| Plaintext | Ciphertext |

The SSID field of the third Probe Request frame broadcasted by the mobile phone may be constituted as follows:

| Flag | version | Index | Total len | Payload |
|---|---|---|---|---|
| (4 byte) | (4 bit) | (4 bit) | (1 byte) | (2 byte) |
| XMKL | 1 | 3 | 54 | rs |

| | |
|---|---|
| Plaintext | Ciphertext |

After the smart television receives the first frame, it is found that Total len=54 bytes. However, there are only 24 bytes in Sub Payload. Thus it is learned that the configuration data has been partitioned into several parts, and it is also learned that the current frame is the first frame base on Index=1. In addition, it is learned that the configuration data is configured to instruct the smart television to connect to other APs base on version=1.

After the smart television receives the second frame, it is learned that the current frame is the second frame base on Index=2.

After the smart television receives the third frame, it is learned that the current frame is the third frame base on Index=3.

After receiving three frames, a character string with 52 bytes may be acquired by means of accumulation of the Sub Payload and the other two Payloads, which is exactly equal to Total len-2. Thus both the SSID and the password of the WiFi network are received completely. Afterwards, both the SSID and the password of the WiFi network may be acquired by partitioning the character string with 52 bytes according to the parameters Ssid len=23 and Password len=29.

In Step S1009, the smart television sends a connection request to the WIFI access point according to the received SSID and the received connection password.

In Step S1010, the WIFI access point sends feedback information to the smart television, and a successful connection is established.

In Step S1011, Internet services, for example, downloading movies, is available for the smart television through the WIFI access point.

FIG. 11 is a signaling diagram showing a method for performing configuration according to an exemplary embodiment. In the scenario of the present embodiment, the terminal device is a mobile phone, and the smart television is configured by the terminal device to create the WIFI network, or in other words, the smart television is configured by the terminal device as a WIFI access point.

In Step S1101, the mobile phone broadcasts a Probe Request which may be intercepted by the smart television.

In Step S1102, the smart television feeds back a Probe Response.

Specific contents of the Probe Request are illustrated as below.

For example, the SSID of the WiFi network to be created by the smart television is “MIKLTVOS” (8 bytes), the connection password is “12345678” (8 bytes), the encryption mode is WPA, and the channel number is 6. The combination of the SSID and the password of the WiFi network to be created is “MIKLTVOS12345678” (16 bytes), which does not require partition due to the small number of bytes. The number of bytes, including the length of the fields of encryption mode, the channel number and other fields, is 3. Therefore, the total number of bytes (Total len) of the configuration data is 19.

The SSID field of the Probe Request may be constituted as follows:

| Flag | version | Index | Total len |
|---|---|---|---|
| (4 byte) | (4 bit) | (4 bit) | (1 byte) |
| XMKL | 2 | 1 | 19 |

Plaintext

| Ssid len | Password len | Password type | key_mgmt | channel | Payload |
|---|---|---|---|---|---|
| (6 bit) | (6 bit) | (1 bit) | (3 bit) | (1 byte) | (16 byte) |
| 8 | 8 | 0 | 3:wpa | 6 | MIKLTVOS12345678 |

Ciphertext

After the smart television receives the frame, it is learned that the configuration data is configured to instruct the smart television to configure itself as an AP base on version=2. The smart television may partition the character string “MIKLTVOS12345678” into the SSID and the password of the WiFi network to be created according to the parameters Ssid len=8 and Password len=8, and then the smart television may configure itself as the AP according to information such as the channel, etc.

In Step S1103, the mobile phone sends a connection request to the smart television according to the connection password set previously.

In Step S1104, the smart television sends feedback information to the mobile phone, and a connection is established.

In Step S1105, the mobile phone and the smart television may begin data communications.

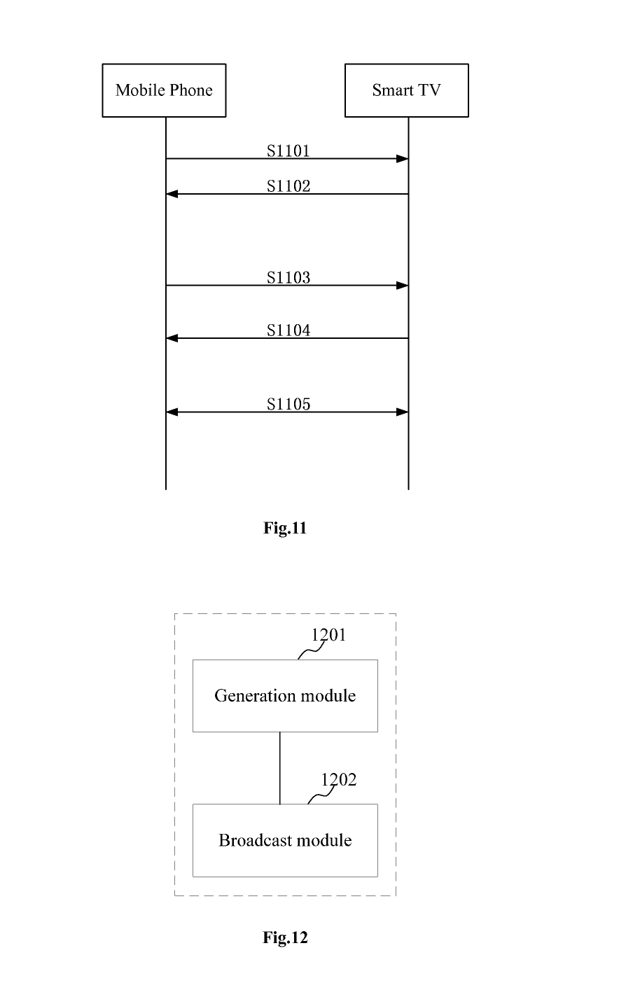

FIG. 12 is a block diagram showing an apparatus for performing configuration according to an exemplary embodiment. The apparatus may be applied to a terminal device. Referring to FIG. 12, the device includes: a generation module 1201, configured to generate a WIFI frame which includes configuration data for configuring a smart television; and a broadcast module 1202, configured to broadcast the WIFI frame so that the smart television may configure itself according to the configuration data after receiving the WIFI frame.

In the present embodiment or other embodiments of the present disclosure, the generation module may be configured to: generate a Probe Request before establishing a communication connection with the smart television, and the configuration data may be placed in the SSID field of the Probe Request.

In the present embodiment or other embodiments of the present disclosure, the configuration data may include an SSID and a connection password.

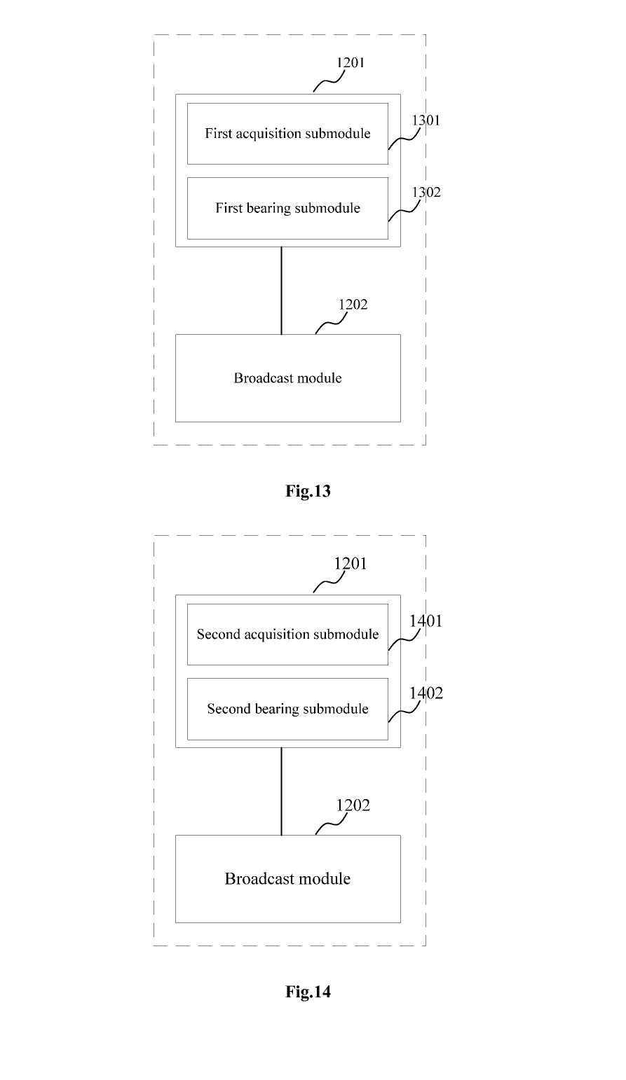

Correspondingly, as shown in FIG. 13, the generation module includes: a first acquisition submodule 1301, configured to acquire SSIDs and connection passwords of networks saved in the terminal device and choose an SSID and a connection password of a network for the configuration of the smart television; and a first bearing submodule 1302, configured to write the SSID and the connection password of the chosen network into the SSID field of Probe Request to generate the Probe Request so that the smart television is able to connect to the chosen network according to the configuration data after receiving the Probe Request.

In the present embodiment or other embodiments of the present disclosure, the configuration data may include an SSID, a connection password, a channel number and an encryption mode.

Correspondingly, as shown in FIG. 14, the generation module includes: a second acquisition submodule 1401, configured to receive an SSID, a connection password, a channel number and an encryption mode inputted from a user; and a second bearing submodule 1402, configured to write the SSID, the connection password, the channel number and the encryption mode inputted by the user into the SSID field of Probe Request to generate the Probe Request so that a wireless network may be created by the smart television according to the configuration data.

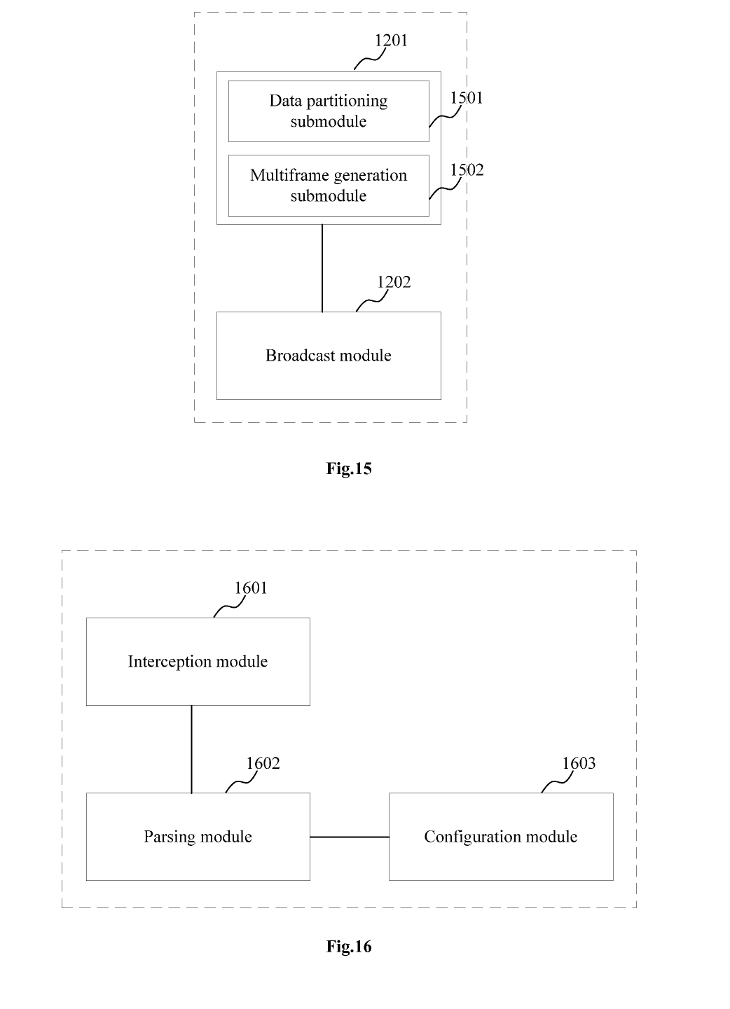

Referring to FIG. 15, in the present embodiment or other embodiments of the present disclosure, when a number of bytes of the configuration data exceeds a preset length of the WIFI frame, the generation module includes: a data partitioning submodule 1501, configured to partition the configuration data into at least two parts according to a preset rule; and a multiframe generation submodule 1502, configured to generate a plurality of the WIFI frames, each of which includes one of the at least two parts.

In the present embodiment or other embodiments of the present disclosure, the WIFI frame broadcasting module may be specifically configured to successively broadcast the plurality of the WIFI frames generated so that the smart television is able to configure itself according to the configuration data by combining the part of configuration data in the predefined field of each WIFI frame according to the preset rule after receiving the plurality of the WIFI frames.

With regard to the apparatus in the above embodiment, detailed description of specific modes for conducting operation of modules has been made in the embodiment related to the method, thus detailed illustration will be omitted herein.

FIG. 16 is a block diagram showing an apparatus for performing configuration according to an exemplary embodiment. The apparatus may be applied to a smart television. Referring to FIG. 16, the apparatus may include: an interception module 1601, configured to intercept a WIFI frame sent by a terminal device, the WIFI frame including configuration data for configuring the smart television; a parsing module 1602, configured to parse the WIFI frame and acquire the configuration data after intercepting the WIFI frame; and a configuration module 1603, configured to conduct a configuration according to the configuration data.

In the present embodiment or other embodiments of the present disclosure, the WIFI frame may be a Probe Request.

The parsing module is configured to parse the SSID field of Probe Request and acquire the configuration data after intercepting the Probe Request.

In the present embodiment or other embodiments of the present disclosure, the configuration data includes an SSID and a connection password. The configuration module is configured to connect a corresponding network according to the SSID and the connection password.

Alternatively, the configuration data includes an SSID, a connection password, a channel number and an encryption mode. The configuration module is configured to create a wireless network according to the SSID, the connection password, the channel number and the encryption mode.

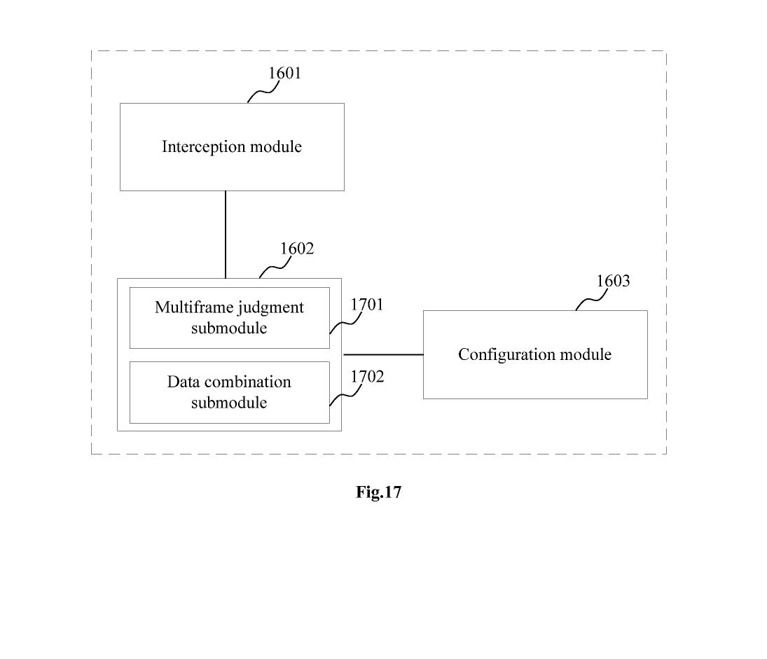

Referring to FIG. 17, in the present embodiment or other embodiments of the present disclosure, the parsing module includes: a multiframe judgment submodule 1701, configured to judge whether there are multiple Probe Requests intercepted and notify a data combination submodule 1702 when there are the plurality of the Probe Requests intercepted; and a data combination submodule 1702, configured to acquire configuration data by respectively parsing SSID fields of Probe Requests received and combining each part of data acquired by parsing the SSID fields according to a preset rule.

With regard to the device in the above embodiment, detailed description of specific modes for conducting operation of modules has been made in the embodiment related to the method, thus detailed illustration will be omitted herein.

The present disclosure also discloses a first terminal device for performing configuration, including: a processor; and a memory configured to store instructions executable by the processor.

The processor is configured to: generate a WIFI frame which includes configuration data for configuring a second terminal device and broadcast the WIFI frame so that the second terminal device is able to configure itself according to the configuration data after receiving the WIFI frame.

The present disclosure also discloses a non-transitory computer-readable storage medium, wherein instructions in the storage medium are executed by the processor of a first terminal device so that the first terminal device may execute a method for performing configuration, and the method includes: generating a WIFI frame, which includes configuration data for configuring a second terminal device; and broadcasting the WIFI frame so that the second terminal device is able to configure itself according to the configuration data after receiving the WIFI frame.

The present disclosure also discloses a second terminal device for performing configuration, including: a processor; and a memory configured to store instructions executable by the processor.

The processor is configured to: intercept a WIFI frame sent by a first terminal device, the WIFI frame includes configuration data for configuring the second terminal device, acquiring the configuration data by parsing the WIFI frame, and perform a configuration according to the configuration data.

The present disclosure also discloses a non-transitory computer-readable storage medium, wherein instructions in the storage medium are executed by the processor of a second terminal device so that the second terminal device may execute a method for performing configuration, and the method includes: intercepting a WIFI frame sent by a first terminal device, the WIFI frame including configuration data for configuring the second terminal device, acquiring the configuration data by parsing the WIFI frame, and performing a configuration according to the configuration data.

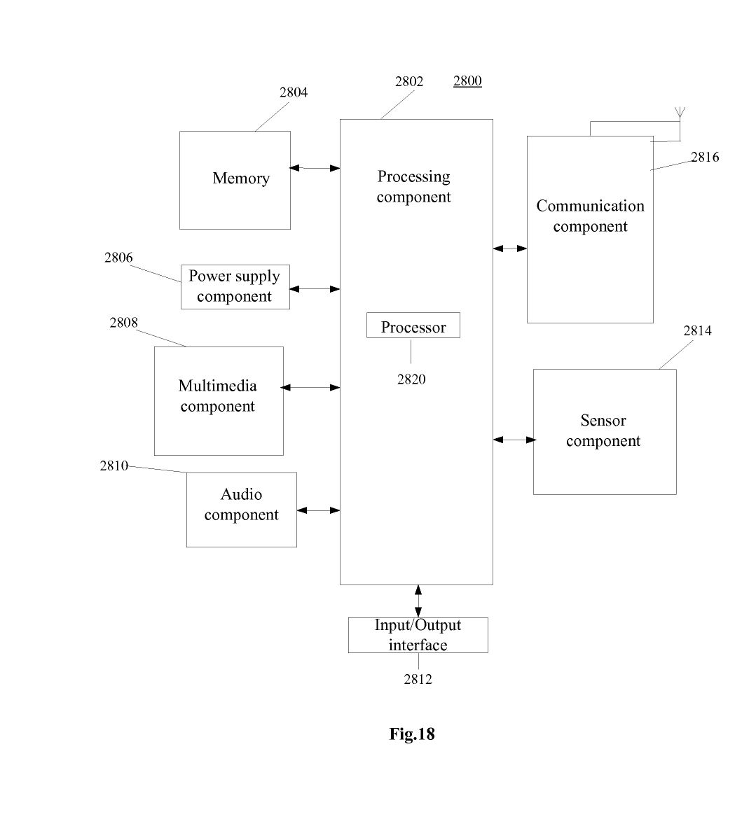

FIG. 18 is a block diagram showing a terminal device for performing configuration according to an exemplary embodiment. For example, the terminal device 2800 may be a mobile telephone, a computer, a digital broadcasting terminal, a message transceiver device, a games console, a tablet device, a medical device, a fitness facility, a PDA (personal digital assistant) and the like.

Referring to FIG. 18, the terminal device 2800 may include one or more components as below: a processor component 2802, a memory 2804, a power supply component 2806, a multimedia component 2808, an audio component 2810, an input/output (I/O) interface 2812, a sensor component 2814 and a communication component 2816.

The processor module 2802 usually controls the overall operation of the terminal device 2800, for example, display, telephone call, data communication, and operation associated with camera operation and record operation. The processor component 2802 may include one or multiple processors 2820 for executing instructions so as to complete steps of above method in part or in whole. In addition, the processor component 2802 may include one or multiple modules for the convenience of interaction between the processor component 2802 and other components. For example, the processor component 2802 may include a multimedia module for the convenience of interaction between the multimedia component 2808 and the processor component 2802.

The memory 2804 is configured to store data of different types so as to support the operation of the terminal device 2800. Examples of the data include instructions of any application program or method, contact data, phonebook data, message, picture and video, etc., which are operated on the terminal device 2800. The memory 2804 may be realized by volatile or non-volatile memory device of any type or combination thereof, for example, static random access memory (SRAM), electrically erasable programmable read-only memory (EEPROM), erasable programmable read only memory (EPROM), programmable read-only memory (PROM), read-only memory (ROM), magnetic memory, flash memory, magnetic disk or optical disk.

The power supply component 2806 provides power for components of the terminal device 2800. The power supply component 2806 may include a power management system, one or multiple power supplies, and other components associated with generation, management and power distribution of the terminal device 2800.

The multimedia component 2808 includes a screen between the terminal device 2800 and a user and for providing an output interface. In some embodiments, the screen may include an LCD (Liquid Crystal Display) and a touch panel (TP). If the screen includes a touch panel, the screen may be realized as a touch screen for receiving input signal from users. The touch panel includes one or multiple touch sensors for sensing gestures on the touch panel, for example, touching and sliding, etc. The touch sensor not only can sensor trip boundary of touching or sliding, but also can detect the duration and pressure related to the touching or sliding operation. In some embodiments, the multimedia component 2808 includes a front-facing camera and/or a rear-facing camera. When the terminal device 2800 is under an operation mode, for example, capture mode or video mode, the front-facing camera and/or the rear-facing camera may receive external multimedia data. Each front-facing camera and rear-facing camera may be a fixed optical lens system or have focal length and optical zoom capacity.

The audio component 2810 is configured to output and/or input audio signal. For example, the audio component 2810 includes a microphone (MIC); when the terminal device 2800 is under an operation mode such as call mode, record mode and speech recognition mode, the microphone is configured to receive external audio signal. The audio signal received may be further stored in the memory 2804 or sent out by the communication component 2816. In some embodiments, the audio component 2810 also includes a loudspeaker for outputting audio signal.

The I/O interface 2812 provides an interface for the processor component 2802 and a peripheral interface module, and the peripheral interface module may be a keyboard, a click wheel and buttons, etc. These buttons may include but not limited to: home button, volume button, start button and locking button.

The sensor component 2814 includes one or more sensors for providing the terminal device 2800 with state evaluation from all aspects. For example, the sensor component 2814 may detect the on/off state of the terminal device 2800, relative positioning of components, for example, the components are the displayer and keypads of the terminal device 2800; the sensor component 2814 also may detect the position change of the terminal device 2800 or a component thereof, the presence or absence of users' touch on the terminal device 2800, the direction or acceleration/deceleration of the terminal device 2800, and temperature variation of the terminal device 2800. The sensor component 2814 may also include a proximity detector, which is configured to detect the presence of nearby objects in case of no physical touch. The sensor component 2814 may also include an optical sensor, for example, CMOS or CCD image sensor for imaging. In some embodiments, the sensor component 2814 may also include an acceleration sensor, a gyro sensor, a magnetic sensor, a pressure sensor, or a temperature sensor.

The communication component 2816 is configured to facilitate wired communication or wireless communication between the terminal device 2800 and other equipment. The terminal device 2800 is available for access to wireless network based on communication standards, for example, WIFI, 2G or 3G, or combination thereof. In an exemplary embodiment, the communication component 2816 receives by means of a broadcast channel the broadcast signal or broadcast-related information from external broadcast management systems. In an exemplary embodiment, the communication component 2816 also includes a near field communication (NFC) module for promoting short-range communication. For example, the NFC module may be realized on the basis of Radio Frequency Identification (RFID) Technology, Infrared Data Association (IrDA) Technology, Ultra-wide Bandwidth (UWB) Technology, Bluetooth (BT) Technology and other technologies.

In exemplary embodiments, the terminal device 2800 may be realized by one or more application specific integrated circuits (ASIC), digital signal processors (DSP), digital signal processing devices (DSPD), programmable logic devices (PLD), field programmable gate arrays (FPGA), controllers, microcontrollers, microprocessors or other electronic components, configured to execute the above method for the terminal side.

In exemplary embodiments, there is also provided a non-transitory computer-readable storage medium, for example, a memory 2804 including instructions executable by the processor 2820 of the terminal device 2800 for performing the above-described methods. For example, the non-transitory computer-readable storage medium may be ROM, random access memory (RAM), CD-ROM, magnetic tape, floppy disk and optical data storage device, etc.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for performing configuration in a first terminal device, comprising:
generating a WIFI frame containing configuration data for configuring a second terminal device; and
broadcasting the WIFI frame so that the second terminal device is able to configure itself according to the configuration data after receiving the WIFI frame.

2. The method of claim 1, wherein the WIFI frame is generated by adding the configuration data into a predefined field of the WIFI frame, and wherein the WIFI frame comprises a Management Frame, a Control Frame or a Data Frame.

3. The method of claim 2, wherein the configuration data comprises: an SSID (Service Set Identifier) and a connection password; and
wherein adding the configuration data into the predefined field of the WIFI frame comprises:
acquiring SSIDs and connection passwords of networks saved in the first terminal device;
choosing an SSID and a connection password of a network from the acquired SSIDs and the acquired connection passwords for the configuration of the second terminal device; and
writing the SSID and the connection password of the chosen network into the predefined field of the WIFI frame to generate the WIFI frame, so that the second terminal device is able to connect with the chosen network according to the configuration data after receiving the WIFI frame.

4. The method of claim 2, wherein the configuration data comprises: an SSID, a connection password, a channel number and an encryption mode; and
wherein adding the configuration data into the predefined field of the WIFI frame comprises:
receiving an SSID, a connection password, a channel number and an encryption mode inputted from a user; and
writing the SSID, the connection password, the channel number and the encryption mode into the predefined field of the WIFI frame to generate the WIFI frame, so that the second terminal device is able to create a wireless network according to the configuration data after receiving the WIFI frame.

5. The method of claim 1, wherein generating the WIFI frame comprises:
partitioning the configuration data into at least two parts according to a preset rule if the number of bytes of the configuration data exceeds a predefined threshold; and
generating a plurality of WIFI frames, each of which comprising one of the at least two parts.

6. The method of claim 5, wherein broadcasting the WIFI frame comprises:
successively broadcasting the plurality of WIFI frames so that the second terminal device is able to configure itself according to the configuration data by combining the part of configuration data in the predefined field of each WIFI frame according to the preset rule after receiving the plurality of the WIFI frames.

7. The method of claim 1, wherein the WIFI frame is generated before establishing a communication connection with the second terminal device.

8. A method for performing configuration in a second terminal device, comprising:
intercepting a WIFI frame sent from a first terminal device, the WIFI frame containing configuration data for configuring the second terminal device;
acquiring the configuration data by parsing the WIFI frame; and
performing configuration according to the configuration data.

9. The method of claim 8, wherein the configuration data is acquired by parsing a predefined field of the WIFI frame.

10. The method of claim 9, wherein the configuration data comprises: an SSID (Service Set Identifier) and a connection password; and
wherein performing configuration according to the configuration data comprises: connecting with a corresponding network according to the SSID and the connection password.

11. The method of claim 9, wherein the configuration data comprises: an SSID, a connection password, a channel number and an encryption mode; and
wherein performing configuration according to the configuration data comprises: creating a wireless network according to the SSID, the connection password, the channel number and the encryption mode.

12. The method of claim 9, wherein acquiring the configuration data by parsing the WIFI frame comprises:
judging whether a plurality of WIFI frames are intercepted and whether the predefined field of each WIFI frame comprises a part of configuration data; and
acquiring the configuration data by combining the part of configuration data of each WIFI frame according to a preset rule, if the plurality of the WIFI frames are intercepted and the predefined field of each WIFI frame comprises the part of the configuration data.

13. A first terminal device for performing configuration, comprising:
a processor; and
a memory configured to store instructions executable by the processor;
wherein the processor is configured to perform:
generating a WIFI frame containing configuration data for configuring a second terminal device; and
broadcasting the WIFI frame so that the second terminal device is able to configure itself according to the configuration data after receiving the WIFI frame.

14. The first terminal device of claim 13, wherein the WIFI frame is generated by adding the configuration data into a predefined field of the WIFI frame, and wherein the WIFI frame comprises a Management Frame, a Control Frame or a Data Frame.

15. The first terminal device of claim 14, wherein the configuration data comprises: an SSID (Service Set Identifier) and a connection password; and
wherein adding the configuration data into the predefined field of the WIFI frame comprises:
acquiring SSIDs and connection passwords of networks saved in the first terminal device;
choosing an SSID and a connection password of a network from the acquired SSIDs and the acquired connection passwords for the configuration of the second terminal device; and
writing the SSID and the connection password of the chosen network into the predefined field of the WIFI frame to generate the WIFI frame, so that the second terminal device is able to connect with the chosen network according to the configuration data after receiving the WIFI frame.

16. The first terminal device of claim 14, wherein the configuration data comprises: an SSID, a connection password, a channel number and an encryption mode; and
wherein adding the configuration data into the predefined field of the WIFI frame comprises:
receiving an SSID, a connection password, a channel number and an encryption mode inputted from a user; and
writing the SSID, the connection password, the channel number and the encryption mode into the predefined field of the WIFI frame to generate the WIFI frame, so that the second terminal device is able to create a wireless network according to the configuration data after receiving the WIFI frame.

17. The first terminal device of claim 13, wherein generating the WIFI frame comprises:
partitioning the configuration data into at least two parts according to a preset rule if the number of bytes of the configuration data exceeds a predefined threshold; and
generating a plurality of WIFI frames, each of which comprising one of the at least two parts.

18. The first terminal device of claim 17, wherein broadcasting the WIFI frame comprises:
successively broadcasting the plurality of WIFI frames so that the second terminal device is able to configure itself according to the configuration data by combining the part of configuration data in the predefined field of each WIFI frame according to the preset rule after receiving the plurality of WIFI frames.

19. The first terminal device of claim 13, wherein the WIFI frame is generated before establishing a communication connection with the second terminal device.

20. A second terminal device for performing configuration, comprising:
a processor; and
a memory configured to store instructions executable by the processor;
wherein the processor is configured to performing:
intercepting a WIFI frame sent from a first terminal device, the WIFI frame containing configuration data for configuring the second terminal device;
acquiring the configuration data by parsing the WIFI frame; and
performing configuration according to the configuration data.

21. The second terminal device of claim 20, wherein the configuration data is acquired by parsing a predefined field of the WIFI frame.

22. The second terminal device of claim 21, wherein the configuration data comprises: an SSID (Service Set Identifier) and a connection password; and
wherein performing configuration according to the configuration data comprises:
connecting with a corresponding network according to the SSID and the connection password.

23. The second terminal device of claim 21, wherein the configuration data comprises: an SSID, a connection password, a channel number and an encryption mode; and
wherein performing configuration according to the configuration data comprises:
creating a wireless network according to the SSID, the connection password, the channel number and the encryption mode.

24. The second terminal device of claim 21, wherein acquiring the configuration data by parsing the WIFI frame comprises:
judging whether a plurality of WIFI frames are intercepted and whether the predefined field of each WIFI frame comprises a part of configuration data; and
acquiring the configuration data by combining the part of configuration data of each WIFI frame according to a preset rule, if the plurality of WIFI frames are intercepted and the predefined field of each WIFI frame comprises the part of configuration data.
